(19) United States
(12) Patent Application Publication
(10) Pub. No.: US 2025/0173579 A1
(43) Pub. Date: May 29, 2025

(54) METHOD AND APPARATUS FOR MULTI-DRONE ROUNDUP OF HIERARCHICAL COLLABORATIVE LEARNING, ELECTRONIC DEVICE AND MEDIUM

(71) Applicant: BEIHANG UNIVERSITY, Beijing (CN)

(72) Inventors: Yumeng LI, Beijing (CN); Zhengzhi Yang, Beijing (CN); Tong Guo, Beijing (CN); Tao Wang, Beijing (CN); Lei Zheng, Beijing (CN); Wenbo Du, Beijing (CN)

(21) Appl. No.: 18/955,772

(22) Filed: Nov. 21, 2024

(30) Foreign Application Priority Data
Nov. 29, 2023 (CN) 202311605045.7

(51) Int. Cl. G06N 3/098; G06N 3/045

(52) U.S. Cl. CPC G06N 3/098; G06N 3/045

(57) ABSTRACT

The present application provides a method and apparatus for multi-drone round-up of hierarchical collaborative learning, an electronic device and a medium. The method includes: determining, according to the current agent joint state and the current escape target state, a present target stage task based on a top-layer decision-making network of a hierarchical decision-making network, inputting a task parameter corresponding to the target stage task into a bottom-layer decision-making network of the hierarchical decision-making network, and obtaining an action decision-making result according to an agent state and received communication data by a strategy network of each agent after obtaining the task parameter; controlling, according to the action decision-making result obtained by the strategy network of each agent, each agent to perform a corresponding maneuver action to execute a multi-drone collaborative pursuit task under the target stage task.

### CROSS-REFERENCE TO RELATED APPLICATION

This application claims priority to Chinese Patent Application No. 202311605045.7, filed on Nov. 29, 2023, which is hereby incorporated by reference in its entirety.

### TECHNICAL FIELD

The present application relates to an unmanned aerial vehicle cluster technology and, in particular, to a method and apparatus for multi-drone round-up of hierarchical collaborative learning, an electronic device and a medium.

### BACKGROUND

With the rapid development and popularization of unmanned aerial vehicle technology, the unmanned aerial vehicle has been widely used in many fields. However, since the characteristics of running of the unmanned aerial vehicle, such as large concealment and strong randomness, “black flight” incidents that break into public areas and sensitive areas without permission occur frequently, which poses a great threat to public safety. In the mainstream methods to counter “black flight” unmanned aerial vehicles, laser attack, electromagnetic interference and other methods may cause invading unmanned aerial vehicles to be destroyed and fall, which threaten the safety of ground targets. The collaborative round-up method of multiple unmanned aerial vehicles could more flexibly and reliably eliminate security risks caused by the invasion of “black flight” unmanned aerial vehicles by controlling multiple unmanned aerial vehicles with capture devices to collaboratively track and hang nets to intercept “black flight” escape targets, which has already gained close attention.

Reinforcement learning could feed back every action of an agent by modeling the environment and maximize a future expected gain of one agent in the current state by setting an objective function of cumulative rewards, so as to assist the agent to take more sensible behavior and actions in each state. Deep reinforcement learning is a kind of algorithm using neural networks to optimize agent policies, by the function of storing parameters of the neural networks, the dimension disaster problem in traditional reinforcement learning algorithms, such as time sequence difference and realistic strategy difference algorithm, is eliminated, which provides an idea for real-time calculation and has become a frequently used agent path planning method. However, existing deep reinforcement learning methods have a huge union action and a huge state space in a collaborative pursuit training process of multiple unmanned aerial vehicles, which lead to a slow convergence of agent strategy, a poor collaboration of pursuit strategy and a poor effect of path planning.

### SUMMARY

The present application provides a method and apparatus for multi-drone round-up of hierarchical collaborative learning, an electronic device and a medium, which are used to effectively improve a joint pursuit decision-making effect of the agent and realize multi-drone collaborative round-up.

In one aspect, the present application provides a method for multi-drone round-up of hierarchical collaborative learning, including:
acquiring a current agent joint state and a current escape target state;
determining, according to the current agent joint state and the current escape target state, a present target stage task based on a top-layer decision-making network of a hierarchical decision-making network, inputting a task parameter corresponding to the target stage task into a bottom-layer decision-making network of the hierarchical decision-making network, and obtaining an action decision-making result according to an agent state and received communication data by a strategy network of each agent after obtaining the task parameter; and
controlling, according to the action decision-making result obtained by the strategy network of each agent, each agent to perform a corresponding maneuver action to execute a multi-drone collaborative pursuit task under the target stage task; where the hierarchical decision-making network is a trained network, training is performed based on a reward function of each stage task in multiple stage tasks, and a different stage task has a different reward function.

In an implementation, the method further includes:
splitting a pursuit task into the multiple stage tasks and setting a reward function for each stage task; and constructing the hierarchical decision-making network, where the top-layer decision-making network is used for determining a current stage task according to the agent joint state and the escape target state, the bottom-layer decision-making network includes a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
updating a network parameter of the hierarchical decision-making network according to the reward value to train the hierarchical decision-making network; where a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

In an implementation, before updating the network parameter of the hierarchical decision-making network according to the reward value, the method further includes:
initializing a flight airspace environment, where the flight airspace environment includes an area size, a building set and characteristic information of a building;
initializing an agent parameter in an agent cluster, where the agent parameter includes a position of each agent, transmitting power of a communication device, a radius of observation range and a maneuvering attribute parameter; and
setting an escape target parameter, where the escape target parameter includes a position of an escape target, a position of an invasion target, an escape strategy and a maneuvering attribute parameter.

In an implementation, the multiple stage tasks include at least two of the following: a searching task, an approaching task, an expanding task, a surrounding task, a converging task or a capture task;
where an objective of a reward function corresponding to the searching task includes: maximizing and enlarging a searching coverage range under a condition of keeping internal communication of an agent cluster, and searching an unsearched position of the agent cluster;
where an objective of a reward function corresponding to the approaching task includes: the agent cluster approaching the escape target to the most-rapid extent;
where an objective of a reward function corresponding to the expanding task includes: the agent cluster expanding along a flank direction of an escape target orientation after approaching the escape target;
where an objective of a reward function corresponding to the surrounding task includes: the agent cluster surrounding based on a formation formed by expanding to encircle the escape target;
where an objective of a reward function corresponding to the converging task includes: the agent cluster converging encirclement; and
where an objective of a reward function corresponding to the capture task includes: a distance between the agent and the escape target is less than a preset distance threshold, and the agent cluster is evenly distributed in the encirclement.

In an implementation, the top-layer decision-making network is a deep Q network.

In another aspect, the present application provides an apparatus for multi-drone round-up of hierarchical collaborative learning, including:
an acquiring module, configured to acquire a current agent joint state and a current escape target state;
a decision-making module, configured to determine, according to the current agent joint state and the current escape target state, a present target stage task based on a top-layer decision-making network of a hierarchical decision-making network, input a task parameter corresponding to the target stage task into a bottom-layer decision-making network of the hierarchical decision-making network, and obtain an action decision-making result according to an agent state and received communication data by a strategy network of each agent after obtaining the task parameter; and
an executing module, configured to control, according to the action decision-making result obtained by the strategy network of each agent, each agent to perform a corresponding maneuver action to execute a multi-drone collaborative pursuit task under the target stage task; where the hierarchical decision-making network is a trained network, training is performed based on a reward function of each stage task in multiple stage tasks, and a different stage task has a different reward function.

In an implementation, the apparatus further includes: a training module, configured to:
split a pursuit task into the multiple stage tasks and set a reward function for each stage task; and construct the hierarchical decision-making network, where the top-layer decision-making network is used for determining a current stage task according to the agent joint state and the escape target state, the bottom-layer decision-making network includes a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
update a network parameter of the hierarchical decision-making network according to the reward value to train the hierarchical decision-making network; where a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

In an implementation, the apparatus further includes: an initializing module, configured to:
initialize a flight airspace environment, where the flight airspace environment includes an area size, a building set and characteristic information of a building;
initialize an agent parameter in an agent cluster, where the agent parameter includes a position of each agent, transmitting power of a communication device, a radius of observation range and a maneuvering attribute parameter; and
set an escape target parameter, where the escape target parameter includes a position of an escape target, a position of an invasion target, an escape strategy and a maneuvering attribute parameter.

In an implementation, the multiple stage tasks include at least two of the following: a searching task, an approaching task, an expanding task, a surrounding task, a converging task or a capture task;
where an objective of a reward function corresponding to the searching task includes: maximizing and enlarging a searching coverage range under a condition of keeping internal communication of an agent cluster, and searching an unsearched position of the agent cluster;
where an objective of a reward function corresponding to the approaching task includes: the agent cluster approaching the escape target to the most-rapid extent;
where an objective of a reward function corresponding to the expanding task includes: the agent cluster expanding along a flank direction of an escape target orientation after approaching the escape target;
where an objective of a reward function corresponding to the surrounding task includes: the agent cluster surrounding based on a formation formed by expanding to encircle the escape target;
where an objective of a reward function corresponding to the converging task includes: the agent cluster converging encirclement; and
where an objective of a reward function corresponding to the capture task includes: a distance between the agent and the escape target is less than a preset distance threshold, and the agent cluster is evenly distributed in the encirclement.

In an implementation, the top-layer decision-making network is a deep Q network.

In yet another aspect, the present application provides an electronic device, including: a processor and a memory in communication connection with the processor; where the memory stores computer execution instructions, and the processor executes the computer execution instructions stored in the memory to implement the method as described above.

In yet another aspect, the present application provides a computer-readable storage medium, in which computer execution instructions are stored, where the computer execution instructions, when executed by a processor, are used to implement the method as described above.

In the method and apparatus for multi-drone round-up of hierarchical collaborative learning, the electronic device and the medium provided by the present application, a multi-drone collaborative round-up task is decomposed into multiple stage tasks by adopting hierarchical reinforcement learning, a top-layer decision-making network in a hierarchical decision-making network determines a current target stage task according to a current agent joint state and a current escape target state, a bottom-layer decision-making network of each agent in the hierarchical decision-making network determines specific actions of each agent based on the target stage task, a task of each stage is completed in turn to achieve efficient completion of cooperative pursuit, and a reward function is set for each stage task to train the hierarchical decision-making network, which effectively improve a path planning effect of the agent and realize hierarchical and progressive collaborative round-up of an agent cluster.

### BRIEF DESCRIPTION OF DRAWINGS

The drawings here are incorporated into and constitute a part of this description, illustrate embodiments that conform to the present application, and are used to explain the principles of the present application together with the description.

FIG. 1 exemplarily shows a schematic flowchart of a method for multi-drone round-up of hierarchical collaborative learning provided by Embodiment 1 of the present application.

FIG. 2 exemplarily shows a schematic structural diagram of a hierarchical decision-making network provided by Embodiment 1 of the present application.

FIG. 3 exemplarily shows a scenario diagram of a searching task provided by Embodiment 1 of the present application.

FIG. 4 exemplarily shows a scenario diagram of an approaching task provided by Embodiment 1 of the present application.

FIG. 5 exemplarily shows a scenario diagram of an expanding task provided by Embodiment 1 of the present application.

FIG. 6 exemplarily shows a scenario diagram of a surrounding task provided by Embodiment 1 of the present application.

FIG. 7 exemplarily shows a scenario diagram of a converging task provided by Embodiment 1 of the present application.

FIG. 8 exemplarily shows a schematic structural diagram of an apparatus for multi-drone round-up of hierarchical collaborative learning provided by Embodiment 2 of the present application.

FIG. 9 exemplarily shows a schematic structural diagram of an electronic device for multi-drone round-up of hierarchical collaborative learning provided by Embodiment 3 of the present application.

Through the above drawings, explicit embodiments of the present application have been shown, which will be described in more detail later. These drawings and literal descriptions are not intended to limit the scope of the concept of the present application in any way, but to explain the concept of the present application to those skilled in the art by referring to specific embodiments.

### DESCRIPTION OF EMBODIMENTS

Exemplary embodiments will be described in detail here, examples of which are illustrated in the drawings. When the following description relates to the drawings, unless otherwise indicated, the same numbers in different drawings indicate the same or similar elements. The embodiments described in the following exemplary embodiments do not represent all embodiments consistent with the present application. On the contrary, these embodiments are merely examples of devices and methods consistent with some aspects of the present application as detailed in the appended claims.

A module in the present application refers to a functional module or a logic module. The module could be a software form, and its functions are realized by executing program codes by a processor; the module could also be a hardware form. “And/or” describes an association relationship of associated objects, which means that there can be three relationships, for example, “A and/or B” can mean that A exists alone, A and B exist at the same time, B exists alone. The character “/” generally indicates that associated object before and after is an “or” relationship.

First, the nouns involved in the present application are explained.

Unmanned aerial vehicle ad hoc network communication: refers to use of wireless communication devices carried by unmanned aerial vehicles to establish an adaptive and distributed network topology structure for information sharing between multiple unmanned aerial vehicles. In ad hoc networks, each mobile node could serve as a router and cooperate with each other to forward data packets between nodes, so as to realize a distributed communication network. Compared with the traditional communication mode relying on ground base stations, it has the characteristics of high flexibility, wide coverage and strong real-time performance.

Hierarchical reinforcement learning: it is a reinforcement learning method of multi-layer collaborative learning. Its core idea is to decompose an original complex reinforcement learning task into multiple subtasks, and the subtasks are selected by a top-layer module, and the subtasks are assigned to a bottom-layer module to guide the agent to complete. Hierarchical reinforcement learning method has the characteristics of multi-agent collaborative learning, hierarchical task decomposition and adaptive decision-making, etc., and is an important method to solve complex large-scale decision-making problems.

With the rapid development and popularization of unmanned aerial vehicle technology, the unmanned aerial vehicle has been widely used in many fields. However, since the characteristics of running of the unmanned aerial vehicle, such as large concealment and strong randomness, “black flight” incidents that break into public areas and sensitive areas without permission occur frequently, which poses a great threat to public safety. In the mainstream methods to counter “black flight” unmanned aerial vehicles, laser attack, electromagnetic interference and other methods may cause invading unmanned aerial vehicles to be destroyed and fall, which threaten the safety of ground targets. The collaborative round-up method of multiple unmanned aerial vehicles could more flexibly and reliably eliminate security risks caused by the invasion of “black flight” unmanned aerial vehicles by controlling multiple unmanned aerial vehicles with capture devices to collaboratively track and hang nets to intercept “black flight” escape targets, which has already gained close attention.

Reinforcement learning could feed back every action of an agent by modeling the environment and maximize a future expected gain of one agent in the current state by setting an objective function of cumulative rewards, so as to assist the agent to take more sensible behavior and actions in each state. Deep reinforcement learning is a kind of algorithm using neural networks to an optimize agent policies, by the function of storing parameters of the neural networks, the dimension disaster problem in traditional reinforcement learning algorithms, such as time sequence difference and realistic strategy difference algorithm, is eliminated, which provides an idea for real-time calculation and has become a frequently used agent path planning method. However, existing deep reinforcement learning methods have a huge union action and a huge state space in a collaborative pursuit training process of multiple unmanned aerial vehicles, which lead to a slow convergence of agent strategy, a poor coordination of pursuit strategy and a poor effect of path planning.

The method and apparatus for multi-drone round-up of hierarchical collaborative learning, the electronic device and the medium provided by the present application are aimed at solving the above technical problems.

In the method and apparatus for multi-drone round-up of hierarchical collaborative learning, the electronic device and the medium provided by the present application, a multi-drone collaborative round-up task is decomposed into multiple stage tasks by adopting hierarchical reinforcement learning, a top-layer decision-making network in a hierarchical decision-making network determines a current target stage task according to a current agent joint state and a current escape target state, a bottom-layer decision-making network of each agent in the hierarchical decision-making network determines specific actions of each agent based on the target stage task, a task of each stage is completed in turn to achieve efficient completion of cooperative pursuit, and a reward function is set for each stage task to train the hierarchical decision-making network, which effectively improve a path planning effect of the agent and realize hierarchical and progressive collaborative round-up of an agent cluster.

In the following, the solution of the present application will be exemplarily illustrated by specific embodiments. The following specific embodiments could be combined with each other, and the same or similar concepts or processes may not be repeated in some embodiments.

### Embodiment 1

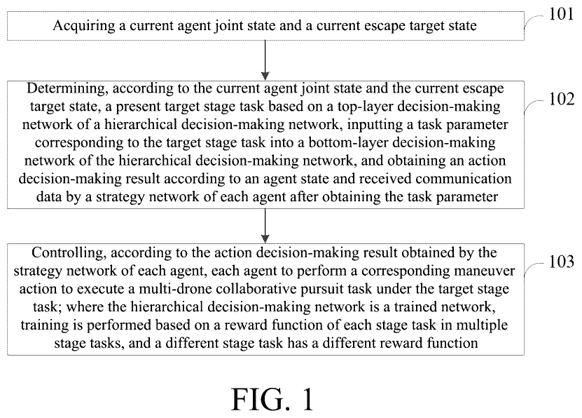

FIG. 1 is a schematic flowchart of a method for multi-drone round-up of hierarchical collaborative learning provided by an embodiment of the present application. As shown in FIG. 1, the method for multi-drone round-up of hierarchical collaborative learning provided by this embodiment may include:
S101, acquiring a current agent joint state and a current escape target state;
S102, determining, according to the current agent joint state and the current escape target state, a present target stage task based on a top-layer decision-making network of a hierarchical decision-making network, inputting a task parameter corresponding to the target stage task into a bottom-layer decision-making network of the hierarchical decision-making network, and obtaining an action decision-making result according to an agent state and received communication data by a strategy network of each agent after obtaining the task parameter; and
S103, controlling, according to the action decision-making result obtained by the strategy network of each agent, each agent to perform a corresponding maneuver action to execute a multi-drone collaborative pursuit task under the target stage task; where the hierarchical decision-making network is a trained network, training is performed based on a reward function of each stage task in multiple stage tasks, and a different stage task has a different reward function.

In practical application, an executive subject of this embodiment could be an apparatus for multi-drone round-up of hierarchical collaborative learning. The apparatus could be realized by a computer program, such as an application software, etc. Or the apparatus could also be realized as a medium storing a relevant computer program, such as a USB flash disk, a cloud disk, etc. Or the apparatus could further be realized by an entity apparatus integrated with or installed with the relevant computer program, such as a chip, a server, etc.

Specifically, in a pursuit process, agents can directly interact with each other through the wireless communication device carried by the agents, and can be used as a relay to transmit information from other agents. Current information of agent i is recorded as oⁱ, and information that agent i receives from other agents is recorded as o_{com}ⁱ.

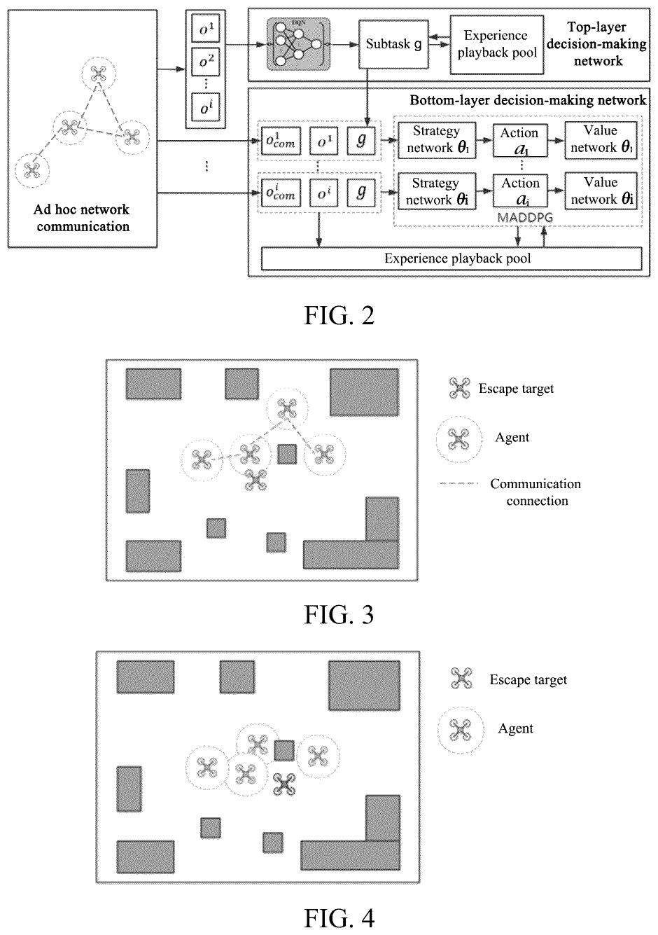

FIG. 2 is a schematic structural diagram of a hierarchical decision-making network provided by an embodiment of the present application. As shown in FIG. 2, the hierarchical decision-making network can be divided into a top-layer decision-making network and a bottom-layer decision-making network. The top-layer decision-making network can acquire global obstacle information, an agent joint state and an escape target state from the communication data oⁱ sent by each agent, and determine a current stage task g according to the global obstacle information, the agent joint state and the escape target state.

The top-layer decision-making network could have various structures, in one example, the top-layer decision-making network is a deep Q network.

The bottom-layer decision-making network is based on a Multi-Agent Deep Deterministic Policy Gradient (MADDPG) method and includes a strategy network and a value network. A strategy network of each agent determines, according to the current agent state information oⁱ and the received communication data o_{com}ⁱ, a specific maneuver action αᵢ based on the current stage task g.

A current state of each agent is acquired by the communication device of the agent, thereby acquiring the current agent joint state and acquiring a current escape target state observed by the agent, and the current agent joint state and the current escape target state are input into the top-layer decision-making network to obtain a present target stage task output by the top-layer decision-making network. After the target stage task is determined by the top-level decision-making network, a task parameter corresponding to the target stage task is input into the strategy network of each agent, and the agent state and the communication data received by the agent are input into the strategy network to obtain an action decision-making result output by the strategy network. According to the action decision-making result output by the strategy network of each agent, each agent is controlled to perform a corresponding maneuver action to perform a multi-drone collaborative pursuit task under the target stage task. In order to accurately judge the current stage task and effectively guide the agent to pursue, a reward function corresponding to each stage task in multiple stage tasks can be set, and the hierarchical decision-making network can be pre-trained based on the reward function of each stage task.

In this example, a multi-drone collaborative round-up task is decomposed into multiple stage tasks by adopting hierarchical reinforcement learning, a top-layer decision-making network in a hierarchical decision-making network determines a current target stage task according to a current agent joint state and a current escape target state, a bottom-layer decision-making network of each agent in the hierarchical decision-making network determines specific actions of each agent based on the target stage task, a task of each stage is completed in turn to achieve efficient completion of cooperative pursuit, and a reward function is set for each stage task to train the hierarchical decision-making network, which effectively improve a path planning effect of the agent and realize hierarchical and progressive collaborative round-up of an agent cluster.

The hierarchical decision-making network needs to be pre-trained before path planning for the agent through the hierarchical decision-making network. In an example, the method further includes:
splitting a pursuit task into the multiple stage tasks and setting a reward function for each stage task; and constructing the hierarchical decision-making network, where the top-layer decision-making network is used for determining a current stage task according to the agent joint state and the escape target state, the bottom-layer decision-making network includes a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
updating a network parameter of the hierarchical decision-making network according to the reward value to train the hierarchical decision-making network; where a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

Specifically, the pursuit task is split into multiple stage tasks, and a reward function is set for each stage task. Multiple stage tasks can be selected according to need of actual production, in an example, multiple stage tasks can include a searching task, an approaching task, an expanding task, a surrounding task, a converging task and a capture task. Still as shown in FIG. 2, an initial hierarchical decision-making network is constructed, where the top-layer decision-making network is used for determining a current stage task g according to the agent joint state and escape target state, the bottom-layer decision-making network includes a strategy network and a value network of each agent, the strategy network is used for obtaining an action decision-making result according to the agent's own information oⁱ and information received from other unmanned aerial vehicles o_{com}ⁱ, and the value network is used for evaluating the maneuver action αᵢ of the agent according to the agent joint state, an escape target and the current stage task g to acquire a reward rᵢ the agent obtains for taking the action αᵢ in an environment. After the current stage task is completed, according to an cumulative reward, the top-layer decision-making network is updated according to the following formula:

$${Q}_{new} ( {s}_{t} , g ) ← ( 1 - α ) {Q}_{old} ( {s}_{t} , g ) + α ( {r}_{t} + γ {max}_{g} {Q}_{old} ( {s}_{t + 1} , g ) )$$

where Q_{old} is a top-layer decision-making network before updating, Q_{new} is a top-layer decision-making network after updating, sₜ is an agent state at a time instant t, sₜ₊₁ is an agent state at a time instant t+1, g is a current stage task, and rₜ is cumulative reward values of all agents at the time instant t.

The bottom-layer decision-making network stores a current subtask, an agent state and other information into an experience playback pool at each step, extracts a batch of samples, and updates a parameter θ_{actor}ⁱ of the strategy network and a parameter θ_{critic}ⁱ of the value network respectively by using a gradient descent method.

$${θ}_{actor}^{i} ← {θ}_{actor}^{i} + α {∇}_{{θ}_{actor}^{i}} J ( {θ}_{actor}^{i} ) .$$

$$J ( {θ}_{actor}^{i} ) = 𝔼 [ {\sum }_{t = 0}^{∞} {γ}^{t} {r}_{t} {∇}_{{θ}_{actor}^{i}} log π ( {a}_{t} \vert ( {o}_{i} , {o}_{com}^{i} , g ) , {θ}_{actor}^{i} ) ]$$

$${θ}_{critic}^{i} ← {θ}_{critic}^{i} - α {∇}_{{θ}_{critic}^{i}} Loss ( {θ}_{critic}^{i} )$$

where θ_{Q} is a parameter of a current top-layer decision-making network Q, θ_{actor}ⁱ is a parameter of a bottom-layer decision-making network corresponding to agent i, α₁ . . . , αₙ are maneuver actions of agent i at different time instants, 0≤γ≤1 is a discount factor for considering the importance of a future reward, θ_{critic}ⁱ is a parameter of a bottom-layer value network corresponding to agent i, and Loss(θ_{critic}) is an error between an estimated value and a real value of the value network's reward for the agent's actions.

After the training is completed, the parameters of the hierarchical decision-making network are stored, when executing a collaborative round-up task in an actual scene, the hierarchical decision-making network can be loaded with the trained network parameters to perform hierarchical action decision-making and complete a collaborative pursuit.

In this example, the maneuver of the agent is evaluated by the value network based on the reward function of each stage task, so as to train the parameters of the hierarchical decision-making network, which can effectively improve an accuracy of determining the stage task as well as planning the pursuit path of the agent in each stage, and improve the collaborative pursuit effect.

In an example, before updating the network parameter of the hierarchical decision-making network according to the reward value, the method further includes:
initializing a flight airspace environment, where the flight airspace environment includes an area size, a building set and characteristic information of a building;
initializing an agent parameter in an agent cluster, where the agent parameter includes a position of each agent, transmitting power of a communication device, a radius of observation range and a maneuvering attribute parameter; and
setting an escape target parameter, where the escape target parameter includes a position of an escape target, a position of an invasion target, an escape strategy and a maneuvering attribute parameter.

Specifically, a round-up process of the agent can be simulated by software during training and testing. Before controlling the agent to carry out the round-up, initialization setting is required. Firstly, the low-altitude airspace environment is initialized, including the area size, a building set B and characteristic information of a building b, where the characteristic information can include a position ρ_{b}, a size s_{b} and a height h_{b}; the agent parameter of the agent cluster is initialized, including the position ρᵢ=(xᵢ, yᵢ, zᵢ) of each agent i, the transmitting power P of the communication device, the radius R_{obs} of the observation range, and the maximum velocity νₘₐₓ^{e}, the maximum acceleration αₘₐₓ^{ρ} and other maneuvering attribute parameters; the escape target parameter is set, where the escape target parameter can include the position ρₑ of the escape target, the position ρ_{target} of the invading target, the escape strategy, and the maximum velocity νₘₐₓ^{e} and the maximum acceleration αₘₐₓ^{e} of the escape target and other maneuvering attribute parameters, where the maximum velocity and the maximum acceleration of the escape target e are not less than the agent, that is, νₘₐₓ^{e}≥νₘₐₓ^{ν}, αₘₐₓ^{e}≥αₘₐₓ^{ρ}. The symbol of each parameter is merely an example, and other symbols can also be selected to represent the respective parameters in practical application, which are not limited here.

In this example, initial parameters required for multi-drone collaborative pursuit are set by performing initialization modeling setting, so as to subsequently simulate the multi-drone collaborative pursuit process based on the model to perform training or testing.

The multi-drone collaborative pursuit task is decomposed into multiple stage tasks, and agents are guided to complete the stage tasks in turn, so as to ultimately solve the collaborative pursuit problem, which can allow the pursuit strategy of the agent to converge more quickly and improve the collaboration of pursuit. There are a variety of decompositions for the stage tasks, in an example, the multiple stage tasks include at least two of the following: a searching task, an approaching task, an expanding task, an surrounding task, a converging task and a capture task;
where an objective of a reward function corresponding to the searching task includes: maximizing and enlarging a searching coverage range under a condition of keeping internal communication of an agent cluster, and searching an unsearched position of the agent cluster;
where an objective of a reward function corresponding to the approaching task includes: the agent cluster approaching the escape target to the most-rapid extent;
where an objective of a reward function corresponding to the expanding task includes: the agent cluster expanding along a flank direction of an escape target orientation after approaching the escape target;
where an objective of a reward function corresponding to the surrounding task includes: the agent cluster surrounding based on a formation formed by expanding to encircle the escape target;
where an objective of a reward function corresponding to the converging task includes: the agent cluster converging encirclement; and
where an objective of a reward function corresponding to the capture task includes: a distance between the agent and the escape target is less than a preset distance threshold, and the agent cluster is evenly distributed in the encirclement.

Specifically, FIG. 3 is an exemplary scenario diagram of a searching task provided by an embodiment of the present application. As shown in FIG. 3, the goal of the searching task is to expand a searching coverage range as much as possible under a premise of keeping reliable communication within the agent cluster, so as to find the invasion target as soon as possible. In a given low-altitude airspace, signal-to-noise ratio of time-varying communication between agents i and j can be calculated by the following way:

$${ρ}_{i} ( {p}_{i} ( t ) ) = \frac{P \cdot {γ}_{j , s} ( t )}{{σ}^{2}}$$

$${γ}_{j , s} ( t ) = \frac{{β}_{s}}{{{d}_{ij} ( t )}^{{α}_{s}}}$$

Where ρⱼ represents a signal-to-noise ratio of agent j; ρᵢ(t) represents a position of the agent i at time t; P represents transmitting power of the communication device; γ_{j,s}(t) represents channel gain between agent j and agent i at a time instant t; s represents propagation condition of a signal, where the propagation condition can be divided into line of sight propagation (LoS, Line of Sight) or non-line of sight propagation (NLoS, Non-line of Sight), which are determined by the position between unmanned aerial vehicles and the distribution of buildings; σ² represents noise power; dᵢⱼ(t) represents a distance between agent i and agent j at a time instant t; and βₛ and αₛ are constants. In order to ensure the reliable communication between agent i and agent j, it is necessary to meet that the signal-to-noise ratio is greater than a minimum threshold ρₜₕ, that is:

ρⱼ(ρᵢ(t))≥ρₜₕ
according to this, the distance between agent i and agent j should not exceed a maximum communication distance Dᵢⱼ(t) when keeping the reliable communication between agent i and agent j, that is:

$${d}_{ij} ( t ) \leq {D}_{ij} ( t ) = {( \frac{P \cdot {β}_{s}}{{σ}^{2} {ρ}_{th}} )}^{\frac{1}{{α}_{s}}}$$

A searching stage reward function r_{search}ⁱ is set as:

$${r}_{search}^{i} \frac{{d}_{ij} ( t )}{{D}_{ij} ( t )} + {r}_{exp}^{i}$$

$$j = arg {min}_{k} \{ {D}_{ik} \vert k ∈ {N}_{i} \}$$

$${r}_{exp}^{i} \{ \begin{matrix}0.1 , & if explore new area \\ 0 , & else\end{matrix}$$

where Nᵢ is a node set that node i need to connect to keep the internal connectivity of the cluster. The reward function allows for a more dispersed distribution of agents to be able to cover a larger area during the searching process under the premise of maintaining a communication connection of the agent cluster, as well as giving additional rewards to agents for searching new positions that have not been searched by the agent cluster. By considering communication constraints between the unmanned aerial vehicles, actions that cause low communication quality are punished by reward shaping to maintain the reliable communication during the decision-making process.

FIG. 4 is an exemplary scenario diagram of an approaching task provided by an embodiment of the present application. As shown in FIG. 4, the goal of the approaching task is to make all agents approach the escape target as soon as possible, reduce a distance from the escape target, and create conditions for subsequent tasks. Exemplarily, an approaching stage reward function r_{approach}ⁱ is set as:

$${r}_{approach}^{i} = - \frac{arccos ( \frac{{v}_{i} ( t ) \cdot ( {p}_{e} ( t ) - {p}_{i} ( t ) )}{\vert {v}_{i} ( t ) \vert \vert {p}_{e} ( t ) - {p}_{t} ( t ) \vert} )}{π} - \frac{{‖ {p}_{e} ( t ) - {p}_{i} ( t ) ‖}_{2}}{L}$$

where νᵢ(t) is a velocity of agent i at a time instant t, ρᵢ(t) is a position of agent i at a time instant t, ρₑ(t) is a position of the escape target at a time instant t. The reward function can make the agent move towards the escape target and reduce the distance to the escape target.

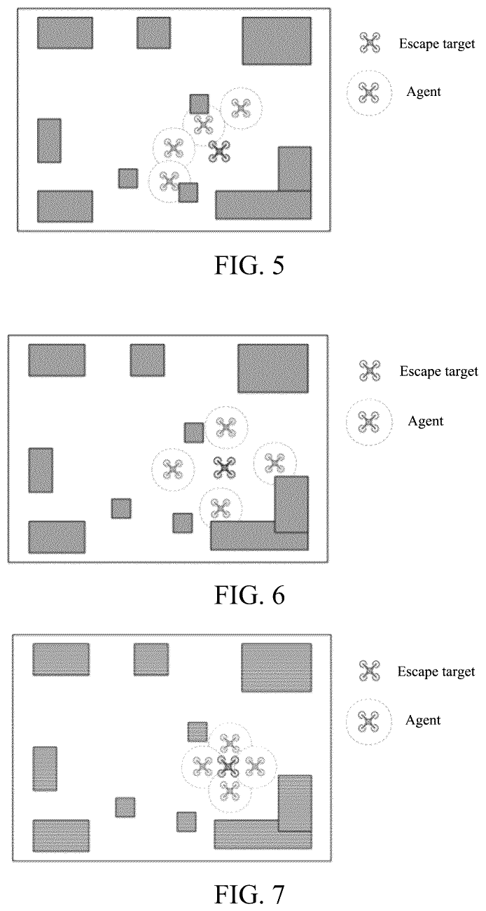

FIG. 5 is an exemplary scenario diagram of an expanding task provided by an embodiment of the present application. As shown in FIG. 5, the purpose of the expanding task is to make the agent gradually expand along a flank direction of the escape target orientation after approaching the escape target, so as to create conditions for subsequent surrounding and encircling. Exemplarily, an order of the expanding task is determined according to a clockwise direction of the agent relative to the target, an expanding stage reward function r_{expand}ⁱ is set as:

$${r}_{expand}^{i} = - {α}_{expand 1} \vert arccos ( \frac{{p}_{e} \cdot {p}_{i}}{\vert {p}_{e} \vert \vert {p}_{i} \vert} ) - rank ( i ) * {Δ}_{θ} ( rank ( i ) ) \vert - {α}_{expand 2} \vert {‖ {p}_{e} - {p}_{i} ‖}_{2} - {Δ}_{D} ( rank ( i ) ) \vert - {α}_{expand 3} {‖ {v}_{i} - \frac{{v}_{e}}{\vert {v}_{e} \vert} \vert {v}_{i} \vert ‖}_{2}$$

where α_{expand1}, α_{expand2}, α_{expand3} are weight parameters, which can be set according to actual production needs; rank(i) is the rank of the relative position angle between agent i and the escape target among all agents, where an order of all agents is a traversal order of the relative position angle between each agent and the escape target in a direction of the velocity of the escape target in a counterclockwise order; Δ_{θ}(k) and Δ_{D}(k) are an angle and a distance of the agent with a preset order k relative to a position of the escape target respectively, which can be performed trimming based on different scenes to achieve different expansion formations. The reward function can make the position angle and the distance between each agent and the escape target meet a preset expected value and the velocity direction close to the velocity direction of the escape target when the agent cluster forms an expansion formation of the escape target.

FIG. 6 is an exemplary scenario diagram of a surrounding task provided by an embodiment of the present application. As shown in FIG. 6, in a surrounding stage task, the agent surrounds the formation formed by expanding, encircles the escape target and limits an activity range of the escape target, and a surrounding reward function r_{surround}ⁱ of this stage is:

$${r}_{surround}^{i} = - {α}_{surround 1} \vert \frac{2 π}{\vert N \vert} rank ( i ) - arccos ( \frac{{p}_{e} \cdot {p}_{i}}{\vert {p}_{e} \vert \vert {p}_{i} \vert} ) \vert + - {α}_{surround 2} \vert {‖ {p}_{i} - \frac{{\sum }_{i ∈ N} {p}_{i}}{\vert N \vert} ‖}_{2} - {‖ {p}_{í} - {p}_{e} ‖}_{2} \vert$$

where α_{surround1} and α_{surround2} are weight coefficients, which can be set according to needs of actual production. In this reward function, the agent cluster can encircles the escape target with a circular surrounding circle, and the escape target is located in the center of the surrounding circle, and each agent is evenly distributed in the formed surrounding circle.

FIG. 7 is an exemplary scenario diagram of a converging task provided by an embodiment of the present application. As shown in FIG. 7, in a converging stage task, the agent cluster gradually converges the encirclement, exemplarily, a converging stage reward function r_{converge}ⁱ is set as:

$${r}_{converge}^{i} = - {α}_{converge 1} \vert \frac{2 π}{\vert N \vert} rank ( i ) - arccos ( \frac{{p}_{e} \cdot {p}_{i}}{\vert {p}_{e} \vert \vert {p}_{i} \vert} ) \vert + - {α}_{converge 2} {‖ {p}_{i} - {p}_{e} ‖}_{2}$$

where α_{converge1} and α_{converge2} are weight coefficients, the reward function can make the agent keep a position angle relative to the escape target, so that the agent cluster can form a surrounding circle evenly and converge a distance continuously.

A capture success condition is that the distance from each agent to the escape target is less than a threshold, and the agents are evenly distributed in the formed encirclement, that is:

$${max}_{i ∈ N} \vert {p}_{i} - {p}_{e} \vert < {ϵ}_{D}$$

$$and$$

$$\vert arccos ( \frac{{p}_{rank ( i + 1 )} \cdot {p}_{rank ( i + 1 )}}{\vert {p}_{rank ( i + 1 )} \vert \vert {p}_{rank ( i + 1 )} \vert} ) - \frac{2 π}{\vert N \vert} rank ( i ) \vert < {ϵ}_{θ} ,$$

$$∀ i ∈ N$$

and each agent can obtain a capture success reward r_{capture} after successful capture.

In addition to a specific reward function in each stage, a general reward function can also be set in an implementation process of the whole pursuit task, including a communication quality reward, an obstacle avoidance reward, a conflict resolution reward, etc. The communication quality reward is a reward when the agent keeps reliable communication with other agents; the obstacle avoidance reward is a reward when the agent avoids obstacles or buildings in the environment; the conflict resolution reward is a reward when the agent resolves a flight conflict.

In this example, by setting a unique reward function of each stage task, the agent can be effectively guided to complete a current stage task and a path planning effect can be improved.

In the method for multi-drone round-up of hierarchical collaborative learning provided by this embodiment, a multi-drone collaborative round-up task is decomposed into multiple stage tasks by adopting hierarchical reinforcement learning, a top-layer decision-making network in a hierarchical decision-making network determines a current target stage task according to a current agent joint state and a current escape target state, a bottom-layer decision-making network of each agent in the hierarchical decision-making network determines specific actions of each agent based on the target stage task, a task of each stage is completed in turn to achieve efficient completion of cooperative pursuit, and a reward function is set for each stage task to train the hierarchical decision-making network, which effectively improve a path planning effect of the agent and realize hierarchical and progressive collaborative round-up of an agent cluster.

### Embodiment 2

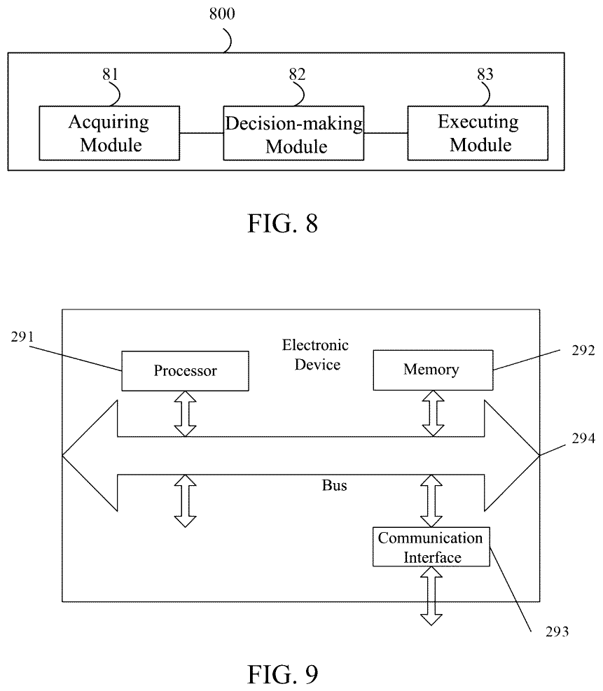

FIG. 8 is a schematic structural diagram of an apparatus for multi-drone round-up of hierarchical collaborative learning provided by an embodiment of the present application. As shown in FIG. 8, the apparatus for multi-drone round-up of hierarchical collaborative learning provided by this embodiment may include:
an acquiring module 81, configured to acquire a current agent joint state and a current escape target state;
a decision-making module 82, configured to determine, according to the current agent joint state and the current escape target state, a present target stage task based on a top-layer decision-making network of a hierarchical decision-making network, input a task parameter corresponding to the target stage task into a bottom-layer decision-making network of the hierarchical decision-making network, and obtain an action decision-making result according to an agent state and received communication data by a strategy network of each agent after obtaining the task parameter; and
an executing module 83, configured to control, according to the action decision-making result obtained by the strategy network of each agent, each agent to perform a corresponding maneuver action to execute a multi-drone collaborative pursuit task under the target stage task; where the hierarchical decision-making network is a trained network, training is performed based on a reward function of each stage task in multiple stage tasks, and a different stage task has a different reward function.

In practical application, the apparatus for multi-drone round-up of hierarchical collaborative learning can be realized by a computer program, such as an application software, etc., or can also be realized as a medium storing a relevant computer program, such as a USB flash disk, a cloud disk, etc., or can also be realized by an entity apparatus integrated with or installed with the relevant computer program, such as a chip, a server, etc.

Specifically, in a pursuit process, agents can directly interact with each other through the wireless communication device carried by the agents, and can be used as a relay to transmit information from other agents. Current information of agent i is recorded as oⁱ, and information that agent i receives from other unmanned aerial vehicles is recorded as o_{com}ⁱ.

The hierarchical decision-making network can be divided into a top-layer decision-making network and a bottom-layer decision-making network, where the top-layer decision-making network could have various structures, in one example, the top-level decision-making network is a deep Q network. The top-layer decision-making network can acquire global obstacle information, an agent joint state and an escape target state from the communication data oⁱ sent by each agent, and determine a current stage task g according to the global obstacle information, the agent joint state and the escape target state.

The bottom-layer decision-making network is based on the MADDPG method and includes a strategy network and a value network. A strategy network of each agent determines, according to the current agent state information oⁱ and the received communication data o_{com}ⁱ, a specific maneuver action αᵢ based on the current stage task g.

A current state of each agent is acquired by the communication device of the agent, thereby acquiring the current agent joint state and acquiring a current escape target state observed by the agent, and the current agent joint state and the current escape target state are input into the top-layer decision-making network to obtain a present target stage task output by the top-layer decision-making network. After the target stage task is determined by the top-level decision-making network, a task parameter corresponding to the target stage task is input into the strategy network of each agent, and the agent state and the communication data received by the agent are input into the strategy network to obtain an action decision-making result output by the strategy network. According to the action decision-making result output by the strategy network of each agent, each agent is controlled to perform a corresponding maneuver action to perform a multi-drone collaborative pursuit task under the target stage task. In order to accurately judge the current stage task and effectively guide the agent to pursue, a reward function corresponding to each stage task in multiple stage tasks can be set, and the hierarchical decision-making network can be pre-trained based on the reward function of each stage task.

In this example, a multi-drone collaborative round-up task is decomposed into multiple stage tasks by adopting hierarchical reinforcement learning, a top-layer decision-making network in a hierarchical decision-making network determines a current target stage task according to a current agent joint state and a current escape target state, a bottom-layer decision-making network of each agent in the hierarchical decision-making network determines specific actions of each agent based on the target stage task, a task of each stage is completed in turn to achieve efficient completion of cooperative pursuit, and a reward function is set for each stage task to train the hierarchical decision-making network, which effectively improve a path planning effect of the agent and realize hierarchical and progressive collaborative round-up of an agent cluster.

The hierarchical decision-making network needs to be pre-trained before path planning for the agent through the hierarchical decision-making network. In an example, the apparatus further includes: a training module, configured to:
split a pursuit task into the multiple stage tasks and set a reward function for each stage task; and construct the hierarchical decision-making network, where the top-layer decision-making network is used for determining a current stage task according to the agent joint state and the escape target state, the bottom-layer decision-making network includes a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
update a network parameter of the hierarchical decision-making network according to the reward value to train the hierarchical decision-making network; where a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

Specifically, the pursuit task is split into multiple stage tasks, and a reward function is set for each stage task. Multiple stage tasks can be selected according to need of actual production, in an example, multiple stage tasks can include a searching task, an approaching task, an expanding task, a surrounding task, a converging task and a capture task. An initial hierarchical decision-making network is constructed, where the top-layer decision-making network is used for determining a current stage task g according to the agent joint state and escape target state, the bottom-layer decision-making network includes a strategy network and a value network of each agent, the strategy network is used for obtaining an action decision-making result according to the agent's own information oⁱ and information received from other unmanned aerial vehicles o_{com}ⁱ, and the value network is used for evaluating the maneuver action αᵢ of the agent according to the agent joint state, an escape target and the current stage task g to acquire a reward rᵢ the agent obtains for taking the action αᵢ in an environment. After the current stage task is completed, according to an cumulative reward, the top-layer decision-making network is updated according to the following formula:

$${Q}_{new} ( {s}_{t} , g ) ← ( 1 - α ) {Q}_{old} ( {s}_{t} , g ) + α ( {r}_{t} + γ {max}_{g} {Q}_{old} ( {s}_{t + 1} , g ) )$$

where Q_{old} is a top-layer decision-making network before updating, Q_{new} is a top-layer decision-making network after updating, sₜ is an agent state at a time instant t, sₜ₊₁ is an agent state at a time instant t, g is a current stage task, and rₜ is cumulative reward values of all agents at the time instant t.

The bottom-layer decision-making network stores a current subtask, an agent state and other information into an experience playback pool at each step, extracts a batch of samples, and updates a parameter o_{actor}ⁱ of the strategy network and a parameter θ_{critic}ⁱ of the value network respectively by using a gradient descent method.

$${θ}_{actor}^{i} ← {θ}_{actor}^{i} + α {∇}_{{θ}_{actor}^{i}} J ( {θ}_{actor}^{i} ) , \\ J ( {θ}_{actor}^{i} ) = 𝔼 [ {\sum }_{t = 0}^{∞} {γ}^{t} {r}_{t} {∇}_{{θ}_{actor}^{i}} log π ( {α}_{t} \vert ( {o}_{i} , {o}_{com}^{i} , g ) , {θ}_{actor}^{i} ) ] , \\ {θ}_{critic}^{i} ← {θ}_{critic}^{i} - α {∇}_{{θ}_{critic}^{i} Loss} ( {θ}_{critic}^{i} )$$

where θ_{Q} is a parameter of a current top-layer decision-making network, θ_{actor}ⁱ is a parameter of a bottom-layer decision-making network corresponding to agent i, αᵢ, . . . , αₙ are maneuver actions of agent i at different time instants, 0≤γ≤1 is a discount factor for considering the importance of a future reward, θ_{critic}ⁱ is a parameter of a bottom-layer value network corresponding to agent i, and Loss(θ_{critic}) is an error between an estimated value and a real value of the value network's reward for the agent's actions.

After the training is completed, the parameters of the hierarchical decision-making network are stored, when executing a collaborative round-up task in an actual scene, the hierarchical decision-making network can be loaded with the trained network parameters to perform hierarchical action decision-making and complete a collaborative pursuit.

In this example, the maneuver action of the agent is evaluated by the value network based on the reward function of each stage task, so as to train the parameters of the hierarchical decision-making network, which can effectively improve an accuracy of determining the stage task as well as planning the pursuit path of the agent in each stage, and improve the collaborative pursuit effect.

In an example, the apparatus further includes: an initializing module, configured to:
initialize a flight airspace environment, where the flight airspace environment includes an area size, a building set and characteristic information of a building;
initialize an agent parameter in an agent cluster, where the agent parameter includes a position of each agent, transmitting power of a communication device, a radius of observation range and a maneuvering attribute parameter; and
set an escape target parameter, where the escape target parameter includes a position of an escape target, a position of an invasion target, an escape strategy and a maneuvering attribute parameter.

Specifically, a round-up process of the agent can be simulated by software during training and testing. Before controlling the agent to carry out the round-up, initialization setting is required. Firstly, the low-altitude airspace environment is initialized, including the area size, a building set B and characteristic information of a building b, where the characteristic information can include a position ρ_{b}, a size s_{b} and a height h_{b}; the agent parameter of the agent cluster is initialized, including the position ρᵢ=(xᵢ, yᵢ, zᵢ) of each agent, the transmitting power P of the communication device, the radius R_{obs} of the observation range, and the maximum velocity νₘₐₓ^{e}, the maximum acceleration αₘₐₓ^{ρ} and other maneuvering attribute parameters; the escape target parameter is set, where the escape target parameter can include the position ρₑ of the escape target, the position ρ_{target} of the invading target, the escape strategy, and the maximum velocity νₘₐₓ^{e} and the maximum acceleration αₘₐₓ^{e} of the escape target and other maneuvering attribute parameters, where the maximum velocity and the maximum acceleration of the escape target e are not less than the agent, that is, νₘₐₓ^{e}≥νₘₐₓ^{ρ}, αₘₐₓ^{e}≥αₘₐₓ^{ρ}. The symbol of each parameter is merely an example, and other symbols can also be selected to represent the respective parameters in practical application, which are not limited here.

In this example, initial parameters required for multi-drone collaborative pursuit are set by performing initialization modeling setting, so as to subsequently simulate the multi-drone collaborative pursuit process based on the model to perform training or testing.

The multi-drone collaborative pursuit task is decomposed into multiple stage tasks, and agents are guided to complete the stage tasks in turn, so as to ultimately solve the collaborative pursuit problem, which can allow the pursuit strategy of the agent to converge more quickly and improve the collaboration of pursuit. There are a variety of decompositions for the stage tasks, in an example, the multiple stage tasks include at least two of the following: a searching task, an approaching task, an expanding task, an surrounding task, a converging task and a capture task;
where an objective of a reward function corresponding to the searching task includes: maximizing and enlarging a searching coverage range under a condition of keeping internal communication of an agent cluster, and searching an unsearched position of the agent cluster;
where an objective of a reward function corresponding to the approaching task includes: the agent cluster approaching the escape target to the most-rapid extent;
where an objective of a reward function corresponding to the expanding task includes: the agent cluster expanding along a flank direction of an escape target orientation after approaching the escape target;
where an objective of a reward function corresponding to the surrounding task includes: the agent cluster surrounding based on a formation formed by expanding to encircle the escape target;
where an objective of a reward function corresponding to the converging task includes: the agent cluster converging encirclement; and
where an objective of a reward function corresponding to the capture task includes: a distance between the agent and the escape target is less than a preset distance threshold, and the agent cluster is evenly distributed in the encirclement.

Specifically, the goal of the searching task is to expand a searching coverage range as much as possible under a premise of keeping reliable communication within the agent cluster, so as to find the invasion target as soon as possible. In a given low-altitude airspace, signal-to-noise ratio of time-varying communication between agents i and j can be calculated by the following way:

$${ρ}_{j} ( {p}_{i} ( t ) ) = \frac{P \cdot {γ}_{j , s} ( t )}{{σ}^{2}} \\ {γ}_{j , s} ( t ) = \frac{{β}_{s}}{{{d}_{ij} ( t )}^{{α}_{s}}}$$

where ρⱼ represents a signal-to-noise ratio of agent j; ρᵢ(t) represents a position of the agent i at time t; P represents transmitting power of the communication device; γ_{j,s}(t) j, represents channel gain between agent j and agent i at a time instant t; s represents propagation condition of a signal, where the propagation condition can be divided into line of sight propagation (LoS, Line of Sight) or non-line of sight propagation (NLoS, Non-line of Sight), which are determined by the position between unmanned aerial vehicles and the distribution of buildings; σ² represents noise power; dᵢⱼ(t) represents a distance between agent i and agent j at a time instant t; and βₛ and αₛ are constants. In order to ensure the reliable communication between agent i and agent j, it is necessary to meet that the signal-to-noise ratio is greater than a minimum threshold ρₜₕ, that is:

ρⱼ(ρᵢ(t))≥ρₜₕ
according to this, the distance between agent i and agent j should not exceed a maximum communication distance Dᵢⱼ(t) when keeping the reliable communication between agent i and agent j, that is:

$${d}_{ij} ( t ) \leq {D}_{ij} ( t ) = {( \frac{P \cdot {β}_{s}}{{σ}^{2} {ρ}_{th}} )}^{\frac{1}{{α}_{s}}}$$

A searching stage reward function r_{search}ⁱ is set as:

$${r}_{search}^{i} = \frac{{d}_{ij} ( t )}{{D}_{ij} ( t )} + {r}_{e xp}^{i} \\ j = arg {min}_{k} \{ {D}_{ik} \vert k ∈ {N}_{i} \} \\ {r}_{e xp}^{i} = \{ \begin{matrix}0.1 , & if explore new area \\ 0 , & else\end{matrix}$$

where Nᵢ is a node set that node i need to connect to keep the internal connectivity of the cluster. The reward function allows for a more dispersed distribution of agents to be able to cover a larger area during the searching process under the premise of maintaining a communication connection of the agent cluster, as well as giving additional rewards to agents for searching new positions that have not been searched by the agent cluster. By considering communication constraints between the unmanned aerial vehicles, actions that cause low communication quality are punished by reward shaping to maintain the reliable communication during the decision-making process.

The goal of the approaching task is to make all agents approach the escape target as soon as possible, reduce a distance from the escape target, and create conditions for subsequent tasks. Exemplarily, an approaching stage reward function r_{approach}ⁱ is set as:

$${r}_{approach}^{i} = \frac{arccos ( \frac{{v}_{i} ( t ) \cdot ( {p}_{e} ( t ) - {p}_{i} ( t )}{\vert {v}_{i} ( t ) \vert \vert {p}_{e} ( t ) - {p}_{i} ( t )} )}{π} - \frac{{‖ {p}_{e} ( t ) - {p}_{i} ( t ) ‖}_{2}}{L}$$

where νᵢ(t) is a velocity of agent i at a time instant t, ρᵢ(t) is a position of agent i at a time instant t, ρₑ(t) is a position of the escape target at a time instant t. The reward function can make the agent move towards the escape target and reduce the distance to the escape target.

The purpose of the expanding task is to make the agent gradually expand along a flank direction of the escape target orientation after approaching the escape target, so as to create conditions for subsequent surrounding and encircling. Exemplarily, an order of the expanding task is determined according to a clockwise direction of the agent relative to the target, an expanding stage reward function r_{expand}ⁱ is set as:

$${r}_{expand}^{i} = - {α}_{expand 1} \vert arccos ( \frac{{p}_{e} \cdot {p}_{i}}{\vert {p}_{e} \vert \vert {p}_{i} \vert} ) - rank ( i ) * {Δ}_{θ} ( rank ( i ) ) \vert - {α}_{expand 2} \vert {‖ {p}_{e} - {p}_{i} ‖}_{2} - {Δ}_{D} ( rank ( i ) ) \vert - {α}_{expand 3} {‖ {v}_{i} - \frac{{v}_{e}}{\vert {v}_{e} \vert} \vert {v}_{i} \vert ‖}_{2}$$

Where α_{expand1}, α_{expand2}, α_{expand3} are weight parameters, which can be set according to actual production needs; rank(i) is the rank of the relative position angle between agent i and the escape target among all agents, where an order of all agents is a traversal order of the relative position angle between each agent and the escape target in a direction of the velocity of the escape target in a counterclockwise order; Δ_{θ}(k) and Δ_{D}(k) are an angle and a distance of the agent with a preset order k relative to a position of the escape target respectively, which can be performed trimming based on different scenes to achieve different expansion formations. The reward function can make the position angle and the distance between each agent and the escape target meet a preset expected value and the velocity direction close to the velocity direction of the escape target when the agent cluster forms an expansion formation of the escape target.

In a surrounding stage task, the agent surrounds the formation formed by expanding, encircles the escape target and limits an activity range of the escape target, and a surrounding reward function r_{surround}ⁱ of this stage is:

$${r}_{surround}^{i} = - {α}_{surround 1} \vert \frac{2 π}{\vert N \vert} rank ( i ) - arccos ( \frac{{p}_{e} \cdot {p}_{i}}{\vert {p}_{e} \vert \vert {p}_{i} \vert} ) \vert + - {α}_{surround 2} \vert {‖ {p}_{i} - \frac{{\sum }_{i ∈ N} {p}_{i}}{\vert N \vert} ‖}_{2} - {‖ {p}_{i} - {p}_{e} ‖}_{2} \vert$$

where α_{surround1} and α_{surround2} are weight coefficients, which can be set according to needs of actual production. In this reward function, the agent cluster can encircles the escape target with a circular surrounding circle, and the escape target is located in the center of the surrounding circle, and each agent is evenly distributed in the formed surrounding circle.

In a converging stage task, the agent cluster gradually converges the encirclement, exemplarily, a converging stage reward function r_{converge}ⁱ is set as:

$${r}_{converge}^{i} = - {α}_{converge 1} \vert \frac{2 π}{\vert N \vert} rank ( i ) - arccos ( \frac{{p}_{e} \cdot {p}_{i}}{\vert {p}_{e} \vert \vert {p}_{i} \vert} ) \vert + - {α}_{converge 2} {‖ {p}_{i} - {p}_{e} ‖}_{2}$$

where α_{converge1} and α_{converge2} are weight coefficients, the reward function can make the agent keep a position angle relative to the escape target, so that the agent cluster can form a surrounding circle evenly and converge a distance continuously.

A capture success condition is that the distance from each agent to the escape target is less than a threshold, and the agents are evenly distributed in the formed encirclement, that is:

$${max}_{i ∈ N} \vert {p}_{i} - {p}_{e} \vert < {ϵ}_{D} \\ and \\ \vert arccos ( \frac{{p}_{rank ( i + 1 )} \cdot {p}_{rank ( i + 1 )}}{\vert {p}_{rank ( i + 1 )} \vert \vert {p}_{rank ( i + 1 )} \vert} ) - \frac{2 π}{\vert N \vert} rank ( i ) \vert < {ϵ}_{θ} , \\ ∀ i ∈ N$$

and each agent can obtain a capture success reward r_{capture} after successful capture.

In addition to a specific reward function in each stage, a general reward function can also be set in an implementation process of the whole pursuit task, including a communication quality reward, an obstacle avoidance reward, a conflict resolution reward, etc. The communication quality reward is a reward when the agent keeps reliable communication with other agents; the obstacle avoidance reward is a reward when the agent avoids obstacles or buildings in the environment; the conflict resolution reward is a reward when the agent resolves a flight conflict.

In this example, by setting a unique reward function of each stage task, the agent can be effectively guided to complete a current stage task and a path planning effect can be improved.

In the apparatus for multi-drone round-up of hierarchical collaborative learning provided by this embodiment, a multi-drone collaborative round-up task is decomposed into multiple stage tasks by adopting hierarchical reinforcement learning, a top-layer decision-making network in a hierarchical decision-making network determines a current target stage task according to a current agent joint state and a current escape target state, a bottom-layer decision-making network of each agent in the hierarchical decision-making network determines specific actions of each agent based on the target stage task, a task of each stage is completed in turn to achieve efficient completion of cooperative pursuit, and a reward function is set for each stage task to train the hierarchical decision-making network, which effectively improve a path planning effect of the agent and realize hierarchical and progressive collaborative round-up of an agent cluster.

### Embodiment 3

FIG. 9 is a schematic structural diagram of an electronic device provided by an embodiment of the present application, as shown in FIG. 9, the electronic device includes:
a processor 291, the electronic device further includes a memory 292; and a communication interface 293 and a bus 294 may also be included. The processor 291, the memory 292 and the communication interface 293 can complete communication with each other through the bus 294. The communication interface 293 could be used for information transmission. The processor 291 could call logic instructions in the memory 292 to execute the method of the above embodiments.

In addition, the logical instructions in the memory 292 in the above can be realized in a form of software functional units and can be stored in a computer-readable storage medium when they are sold or used as independent products.

As a computer-readable storage medium, the memory 292 can be used to store software programs and computer-executable programs, such as program instructions/modules corresponding to the method in the embodiment of the present disclosure. The processor 291 executes functional applications and data processing by running software programs, instructions and modules stored in the memory 292, that is, the method in the above method embodiments is realized.

The memory 292 could include a storage program area and a storage data area, where the storage program area could store an operating system and an application program required by at least one functions; the storage data area could store data created according to use of the terminal device, etc. In addition, the memory 292 could include a high speed random access memory and could also include a non-volatile memory.

An embodiment of the present disclosure provides a non-transitory computer-readable storage medium storing computer-executable instructions, and the computer-executable instructions, when executed by a processor, are used to implement the method described in the foregoing embodiments.

### Embodiment 4

An embodiment of the present disclosure provides a computer program product, including a computer program, where the computer program, when executed by a processor, implements the method provided by any of the embodiments of the present disclosure.

Other implementation solutions of the present application will easily occur to those skilled in the art after considering the description and practicing the invention disclosed herein. The present application is intended to cover any variations, uses or adaptive changes of the present application, which follow general principles of the present application and include common knowledge or conventional technical means in the technical field that are not disclosed in the present application. The description and embodiments are to be regarded as exemplary only, and a true scope and spirit of the present application is be indicated by the following claims.

It should be understood that the present application is not limited to precise structures described above and shown in the drawings, and various modifications and changes can be made without divorcing its scope. The scope of the present application is limited only by appended claims.

What is claimed is:

1. A method for multi-drone round-up of hierarchical collaborative learning, comprising:
acquiring a current agent joint state and a current escape target state;
determining, according to the current agent joint state and the current escape target state, a present target stage task based on a top-layer decision-making network of a hierarchical decision-making network, inputting a task parameter corresponding to the target stage task into a bottom-layer decision-making network of the hierarchical decision-making network, and obtaining an action decision-making result according to an agent state and received communication data by a strategy network of each agent after obtaining the task parameter; and
controlling, according to the action decision-making result obtained by the strategy network of each agent, each agent to perform a corresponding maneuver action to execute a multi-drone collaborative pursuit task under the target stage task; wherein the hierarchical decision-making network is a trained network, training is performed based on a reward function of each stage task in multiple stage tasks, and a different stage task has a different reward function.

2. The method according to claim 1, further comprising:
splitting a pursuit task into the multiple stage tasks and setting a reward function for each stage task; and constructing the hierarchical decision-making network, wherein the top-layer decision-making network is used for determining a current stage task according to the agent joint state and the escape target state, the bottom-layer decision-making network comprises a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
updating a network parameter of the hierarchical decision-making network according to the reward value to train the hierarchical decision-making network; wherein a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

3. The method according to claim 2, wherein before updating the network parameter of the hierarchical decision-making network according to the reward value, the method further comprises:
initializing a flight airspace environment, wherein the flight airspace environment comprises an area size, a building set and characteristic information of a building;
initializing an agent parameter in an agent cluster, wherein the agent parameter comprises a position of each agent, transmitting power of a communication device, a radius of observation range and a maneuvering attribute parameter; and
setting an escape target parameter, wherein the escape target parameter comprises a position of an escape target, a position of an invasion target, an escape strategy and a maneuvering attribute parameter.

4. The method according to claim 1, wherein the multiple stage tasks comprise at least two of the following: a searching task, an approaching task, an expanding task, a surrounding task, a converging task or a capture task;
wherein an objective of a reward function corresponding to the searching task comprises: maximizing and enlarging a searching coverage range under a condition of keeping internal communication of an agent cluster, and searching an unsearched position of the agent cluster;
wherein an objective of a reward function corresponding to the approaching task comprises: the agent cluster approaching the escape target to the most-rapid extent;
wherein an objective of a reward function corresponding to the expanding task comprises: the agent cluster expanding along a flank direction of an escape target orientation after approaching the escape target;
wherein an objective of a reward function corresponding to the surrounding task comprises: the agent cluster surrounding based on a formation formed by expanding to encircle the escape target;
wherein an objective of a reward function corresponding to the converging task comprises: the agent cluster converging encirclement; and
wherein an objective of a reward function corresponding to the capture task comprises: a distance between the agent and the escape target is less than a preset distance threshold, and the agent cluster is evenly distributed in the encirclement.

5. The method according to claim 1, wherein the top-layer decision-making network is a deep Q network.

6. An electronic device, comprising: a processor and a memory in communication connection with the processor;
the memory stores computer execution instructions, and
the processor executes the computer execution instructions stored in the memory, so that the processor is configured to:
acquire a current agent joint state and a current escape target state;
determine, according to the current agent joint state and the current escape target state, a present target stage task based on a top-layer decision-making network of a hierarchical decision-making network, input a task parameter corresponding to the target stage task into a bottom-layer decision-making network of the hierarchical decision-making network, and obtain an action decision-making result according to an agent state and received communication data by a strategy network of each agent after obtaining the task parameter; and
control, according to the action decision-making result obtained by the strategy network of each agent, each agent to perform a corresponding maneuver action to execute a multi-drone collaborative pursuit task under the target stage task; wherein the hierarchical decision-making network is a trained network, training is performed based on a reward function of each stage task in multiple stage tasks, and a different stage task has a different reward function.

7. The electronic device according to claim 6, wherein the processor is further configured to:
split a pursuit task into the multiple stage tasks and setting a reward function for each stage task; and construct the hierarchical decision-making network, wherein the top-layer decision-making network is used for determining a current stage task according to the agent joint state and the escape target state, the bottom-layer decision-making network comprises a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
update a network parameter of the hierarchical decision-making network according to the reward value to train the hierarchical decision-making network; wherein a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

8. The electronic device according to claim 7, wherein the processor is further configured to:
initialize a flight airspace environment, wherein the flight airspace environment comprises an area size, a building set and characteristic information of a building;
initialize an agent parameter in an agent cluster, wherein the agent parameter comprises a position of each agent, transmitting power of a communication device, a radius of observation range and a maneuvering attribute parameter; and
set an escape target parameter, wherein the escape target parameter comprises a position of an escape target, a position of an invasion target, an escape strategy and a maneuvering attribute parameter.

9. The electronic device according to claim 6, wherein the multiple stage tasks comprise at least two of the following: a searching task, an approaching task, an expanding task, a surrounding task, a converging task or a capture task;
wherein an objective of a reward function corresponding to the searching task comprises: maximizing and enlarging a searching coverage range under a condition of keeping internal communication of an agent cluster, and searching an unsearched position of the agent cluster;
wherein an objective of a reward function corresponding to the approaching task comprises: the agent cluster approaching the escape target to the most-rapid extent;
wherein an objective of a reward function corresponding to the expanding task comprises: the agent cluster expanding along a flank direction of an escape target orientation after approaching the escape target;
wherein an objective of a reward function corresponding to the surrounding task comprises: the agent cluster surrounding based on a formation formed by expanding to encircle the escape target;
wherein an objective of a reward function corresponding to the converging task comprises: the agent cluster converging encirclement; and
wherein an objective of a reward function corresponding to the capture task comprises: a distance between the agent and the escape target is less than a preset distance threshold, and the agent cluster is evenly distributed in the encirclement

10. The electronic device according to claim 6, wherein the top-layer decision-making network is a deep Q network.

11. A non-transitory computer-readable storage medium, wherein the computer-readable storage medium stores computer execution instructions, and the computer-readable storage medium causes a processor to execute operations comprising:
acquiring a current agent joint state and a current escape target state;
determining, according to the current agent joint state and the current escape target state, a present target stage task based on a top-layer decision-making network of a hierarchical decision-making network, inputting a task parameter corresponding to the target stage task into a bottom-layer decision-making network of the hierarchical decision-making network, and obtaining an action decision-making result according to an agent state and received communication data by a strategy network of each agent after obtaining the task parameter; and
controlling, according to the action decision-making result obtained by the strategy network of each agent, each agent to perform a corresponding maneuver action to execute a multi-drone collaborative pursuit task under the target stage task; wherein the hierarchical decision-making network is a trained network, training is performed based on a reward function of each stage task in multiple stage tasks, and a different stage task has a different reward function.

12. The non-transitory computer-readable storage medium according to claim 11, wherein the computer-readable storage medium causes the processor to execute operations further comprising:
splitting a pursuit task into the multiple stage tasks and setting a reward function for each stage task; and constructing the hierarchical decision-making network, wherein the top-layer decision-making network is used for determining a current stage task according to the agent joint state and the escape target state, the bottom-layer decision-making network comprises a strategy network and a value network of each agent, the strategy network is used for obtaining the action decision-making result according to the agent state and the received communication data, and the value network is used for calculating, according the agent joint state, an escape target and the current stage task, a reward value obtained by a maneuver action taken by a corresponding agent at a current time instant; and
updating a network parameter of the hierarchical decision-making network according to the reward value to train the hierarchical decision-making network; wherein a network parameter of the top-layer decision-making network is stored and updated according to an accumulated reward after completion of a stage task, and the bottom-layer decision-making network periodically stores the current stage task and the agent state into an experience playback pool and extracts at least one batch of samples from the experience playback pool to update the network parameter by using a gradient descent method.

13. The non-transitory computer-readable storage medium according to claim 12, wherein before updating the network parameter of the hierarchical decision-making network according to the reward value, the computer-readable storage medium causes the processor to execute operations further comprising:
initializing a flight airspace environment, wherein the flight airspace environment comprises an area size, a building set and characteristic information of a building;
initializing an agent parameter in an agent cluster, wherein the agent parameter comprises a position of each agent, transmitting power of a communication device, a radius of observation range and a maneuvering attribute parameter; and
setting an escape target parameter, wherein the escape target parameter comprises a position of an escape target, a position of an invasion target, an escape strategy and a maneuvering attribute parameter.

14. The non-transitory computer-readable storage medium according to claim 11, wherein the multiple stage tasks comprise at least two of the following: a searching task, an approaching task, an expanding task, a surrounding task, a converging task or a capture task;
wherein an objective of a reward function corresponding to the searching task comprises: maximizing and enlarging a searching coverage range under a condition of keeping internal communication of an agent cluster, and searching an unsearched position of the agent cluster;
wherein an objective of a reward function corresponding to the approaching task comprises: the agent cluster approaching the escape target to the most-rapid extent;
wherein an objective of a reward function corresponding to the expanding task comprises: the agent cluster expanding along a flank direction of an escape target orientation after approaching the escape target;
wherein an objective of a reward function corresponding to the surrounding task comprises: the agent cluster surrounding based on a formation formed by expanding to encircle the escape target;
wherein an objective of a reward function corresponding to the converging task comprises: the agent cluster converging encirclement; and
wherein an objective of a reward function corresponding to the capture task comprises: a distance between the agent and the escape target is less than a preset distance threshold, and the agent cluster is evenly distributed in the encirclement.

15. The non-transitory computer-readable storage medium according to claim 11, wherein the top-layer decision-making network is a deep Q network.
